(19) United States
(12) Patent Application Publication
(10) Pub. No.: US 2014/0086138 A1
(43) Pub. Date: Mar. 27, 2014

(54) Method and Device for Processing Data in a Wireless Network

(71) Applicants: Oumer Teyeb, Solna (SE); Simone Redana, Munich (DE); Bernhard Raaf, Neuried (DE); Tobias Bandh, Reutlingen (DE)

(72) Inventors: Oumer Teyeb, Solna (SE); Simone Redana, Munich (DE); Bernhard Raaf, Neuried (DE); Tobias Bandh, Reutlingen (DE)

(73) Assignee: Nokia Siemens Networks Oy, Espoo (FI)

(21) Appl. No.: 13/876,873

(22) PCT Filed: Oct. 1, 2010
(86) PCT No.: PCT/EP2010/064639

§ 371 Date: Aug. 30, 2013

(51) Int. Cl. H04L 5/00; H04B 7/15

(52) U.S. Cl. CPC H04L 5/0073; H04B 7/15
USPC 370/315

(57) ABSTRACT

A method and a device for processing data in a wireless network are provided, wherein a relay node is served by a base station; and wherein the relay node is assigned at least one identification code such that collisions with identification codes of neighboring relay nodes or neighboring base stations are reduced, avoided or solved. Furthermore, a communication system is suggested including at least one such device.

The invention relates to a method and to a device for processing data in a wireless network. Furthermore, a communication system is suggested comprising at least one such device.

Relay stations (RSs) or Relay Nodes (RNs) have been proposed to extend coverage of a cellular system. Further, relay concepts may be utilized for
provisioning of high bit rate coverage in a shadowed environment;
reducing an average radio-transmission power at a user equipment (UE), thereby increasing the battery life of the UE;
enhancing a capacity of the cellular system as well as its effective throughput, e.g., increasing a cell-edge capacity and/or a balancing cell load;
enhancing an overall performance and deployment cost of a radio access network (RAN).

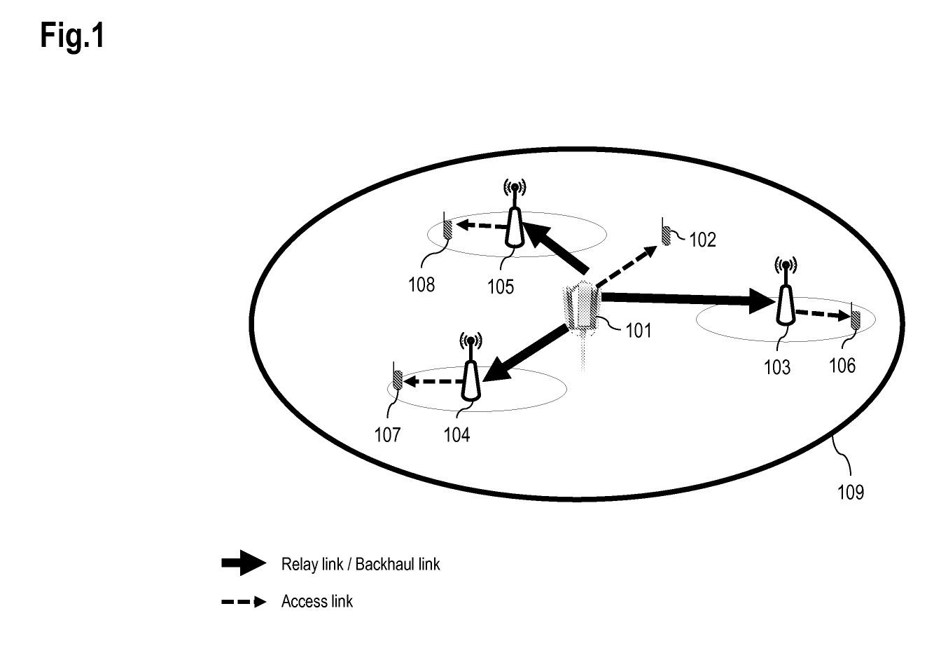

FIG. 1 illustrates a typical deployment scenario of an LTE radio access network (RAN) comprising fixed relay nodes.

FIG. 1 shows a macro cell 109 comprising a base station or eNB 101, which is also referred to as a donor eNB (DeNB). A UE 102 is directly served by the DeNB 101. Furthermore, relay nodes 103, 104, 105 are served by the DeNB 101 via backhaul links. A UE 106 is connected to the relay node 103, a UE 107 is connected to the relay node 104 and a UE 108 is connected to the relay node 105. The link between the UE 102, 106 to 108 and the DeNB or the relay nodes 103 to 105 is also referred to as access link.

There are several kinds of relay systems. One example of a relay system comprises an amplifying and/or forwarding mechanism, e.g., applied in single frequency DVB-H networks. Another example of a relay system utilizes a network coding scheme to improve the overall performance. A common relay type proposed for cellular relaying is a detect/forward type of relay, wherein an input signal is detected and retransmitted using the same procedure as in the original transmission.

Relaying can be realized at different layers of a protocol stack. An amplify-and-forward relaying scheme can be realized at a layer-1 of a protocol stack comprising (some part of) a physical (PHY) layer. Layer-2 relay nodes may include the protocol stack up to MAC/RLC layers, thereby enabling decentralized radio resource management. Layer-3 or higher layer relay nodes could be considered as wireless base stations and may support all protocol layers of a common base station. Such layer-3 relaying functionality may be referred to as type 1 relays pursuant to 3GPP.

According to [R3-091447, “LTE-A RAN3 Baseline Document”, May 2009, http://ftp.3gpp.org/tsg_ran/WG3_Iu/TSGR3_{—}64/Docs/R3-091447.zip], the layer-3 (L3) RN, also referred to as type I RN or self-backhauling RN, where the RN appears as a normal base station towards its UEs, has been taken as a baseline case, i.e. the RN is required to have all the essential release 8 eNB cell parameters and broadcast them so that it could be recognized as a normal eNB cell by the UEs.

In 3GPP LTE networks, the physical cell identifier (PCI, also referred to as Layer 1 (L1) identity), is an important configuration parameter of a radio cell. PCIs are grouped into 168 unique physical layer cell identity groups, each group containing 3 unique identities, thus there are 504 different PCIs altogether [3GPP TS 36.211 E-UTRA; Physical channels and modulation (Release 9), March 2010]. Limiting the number of PCIs reduces efforts spent by the UE for an initial PCI detection during cell search, but such limited number of PCIs inevitably leads to a reuse of the same PCI values in different cells.

When a new eNB or RN is deployed, it requires a PCI for each of its supported cells, avoiding collision with respective neighboring cells. The use of identical PCIs (PCI values) by two adjacent cells results in an interference that prevents an identification of any of the cells. Traditionally, a proper PCI is derived from radio network planning and is part of an initial configuration of a node. According to [3GPP TS 36.902 E-UTRAN; Self-configuring and self-optimizing network (SON) use cases and solutions (Release 9), April 2010], such PCI assignment shall fulfill two conditions:
“collision-free”: the PCI shall be unique in the area covered by the cell;
“confusion-free”: a cell shall not have neighboring cells with identical PCI.

Using the same PCI for two cells that create collision and/or confusion can only be remedied by restarting at least one cell leading to an interruption of service. Therefore, assigning an invalid PCI is highly undesirable and should be avoided.

In a macro eNB only setting, a newly deployed or reconfigured eNB may receive a unique PCI for its cells according to one of the following approaches:
1. Network Planning: During network planning, a planning tool calculates the admissible PCIs for the new cells. These values are based on the estimated neighbor relations of the new cells, provided by cell coverage area assessments. However, the estimated coverage may not accurately reflect the actual coverage that is provided by the eNB after it is powered up. Even if the collision and confusion free criteria is met by the chosen PCIs based on the estimations, in the active network (because of unforeseeable radio signal propagation) there may be other neighbor relations that would put additional constraints on the PCI selection. This means that the PCIs although meant to be collision and confusion free in fact may not fulfill that requirement. In addition, a considerable amount of time may pass after the planning and the radio environment may have been changed when the actual deployment is conducted. The planning conditions are no longer valid. This is in particular true if planning is based on outdated data.
2. Dynamic Allocation during deployment: The PCIs are calculated on-the-fly by an automated Self Optimized Network (SON) function in the Operation and Maintenance (OAM) system. Although this can take into account an up-to-date network state, it is still based on coverage area assessments that are prone to unforeseeable changes in radio propagations (e.g., when leaves fall off trees or snow melts or a building is torn down the propagation conditions change).
3. Random Allocation: The base station simply chooses a random PCI value, and starts using it. Later, when a collision or confusion is detected, the PCI is changed. This approach bears a highly inaccurate PCI selection and leads to a significant amount of eNB restarts; thus, it is a rather inappropriate method for a reliable network.

The allocation of PCIs becomes even more difficult when RNs are deployed, activated, deactivated, relocated, etc. The main reasons for this increased difficulty are:
i) The introduction of RNs can dramatically increase the number of overlapping cells within a given geographical area, especially in dense urban scenarios where relaying is used for capacity enhancement purposes.
ii) Nomadic relays are installed and torn-down in an ad-hoc fashion at random locations, e.g., for emergency or short term capacity enhancement purposes.
iii) Customers may deploy relays without considering any network planning issues and hence without considering PCIs of adjacent base stations or other RNs.
iv) Mobile relay nodes may temporarily traverse an existing base station deployment; such a mobile relay node may provide coverage to users in buses, trains, etc. The movement of relay nodes increases the probability of PCI collision with other static or mobile nodes.

When the RN starts up, it first goes into a UE mode and attaches to the DeNB. Once it has received proper configuration information from the OAM and the DeNB, it switches to an RN mode and starts broadcasting cell information like an eNB.

The problem to be solved is to overcome the disadvantages mentioned above and in particular to minimize the probability of an identifier collision, e.g., a PCI collision, even in case mobile RNs are utilized.

This problem is solved according to the features of the independent claims. Further embodiments result from the depending claims.

In order to overcome this problem, a method is provided for processing data in a wireless network,
wherein a relay node is served by a base station,
wherein the relay node is assigned at least one identification code such that collisions with identification codes of neighboring relay nodes or neighboring base stations are reduced, avoided or solved.

The approach suggested thus reduces the risk of a collision between identification codes that are used for at least two nodes of the mobile communication network, wherein at least one of the nodes is a relay node. The approach also allows resolving a collision once it occurs, is detected or imminent.

The relay node is a node of the wireless network that is in particular connected with the core network via a radio link across a (donor) base station. The relay node may use the same radio technology as does the (donor) base station. The relay node in particular provides a transparent service towards the UEs (i.e. the UE may not have to be aware whether it is connected to a RN or to a base station).

The relay node may be a mobile relay node.

In an embodiment, the identification code is a physical cell identifier.

In another embodiment, a mobility support information of the relay node is conveyed to base stations to which relay nodes can get connected.

Hence, the relay node may get connected to various base stations (donor base stations), in particular in case the relay node is a mobile relay node. The mobility support information, i.e. the fact that the relay node is mobile, could be conveyed to base stations that are, e.g., in a predefined area around the relay node. Hence, the base station becomes aware of this relay node's identification code and it can be avoided that this identification code is used for another base station or relay node.

It is noted that the mobility support information can be conveyed either by the relay node, by a MME or a HSS or any other network node. It is also noted that the identification code can be negotiated between the base stations. Hence, prior to assigning an identification code, a request to a base station may be triggered to determine whether this identification code is admissible. This may reveal potential conflicts before an identification code is assigned to the relay node.

The mobility support information may be conveyed during an initial setup of the relay node.

In a further embodiment, a list of neighbors is conveyed to the relay node, e.g., by the base station that serves the relay node, by the mobile terminal or by another relay node (e.g., via its donor base station), and the identification codes of this list are excluded from being assigned to the relay node.

Such “list of neighbors” may be any kind of information compiled regarding the neighbors determined by the base station. The list of neighbors may include the immediate neighbors and/or the neighbors of the neighbors, etc.

The list of neighbors could be conveyed, e.g., via an X2 interface or via a separate message.

Hence the identification code can be selected such that a conflict with already existing identification codes in the neighborhood of the relay node is avoided.

In a next embodiment, a depth of the list of neighbors can be dynamically set.

The depth of the list of neighbors defines stages of next neighbors: In a first stage, the immediate neighbors are referred to, in a subsequent stage, the immediate neighbors of these neighbors are referred to and so on. The depth of the list of neighbors thus defines the degree of stages for neighbors to be considered. This can be compared to a tree structure with the depth defining a distance from a root node for leaves (neighbors) to be considered. Neighbors that are already mentioned in a previous stage may not be mentioned again in a subsequent stage.

For example, a depth value “0” indicates the parent node (only), a value “1” indicates immediate neighbors (only), a value “2” indicates immediate neighbors and neighbors of the immediate neighbors, etc. The depth can be dynamically set based on the respective scenario used (e.g., a train or a bus to which a relay node is attached). When determining an identification code, the depth value can be taken into account as well, giving higher priority to avoid collisions with identification codes with lower depth values. Hence, a collision with an identification code that has a high depth value, which means that it is typically used by a more distant node is preferred over a collision with an identification code with a low depth value, which is typically used in the vicinity where collisions or confusions would be more severe.

It is also an embodiment that historical information comprising recent identification codes is stored (e.g., by the base station) for a predefined period of time and the recent identification codes are not assigned to the relay node.

Such historical information could be added to the “list of neighbors” providing a combined information for the relay node with identification codes that shall currently not be used.

The historical information can be combined with an expiration date after which this historical information is no longer considered relevant and identification codes that are older than a predetermined time period can be deleted from the list and utilized (unless they are also on the list of neighbors described above). When determining an identification code to be used, the expiration date of this identification code can be taken into account as well, giving a higher priority to identification codes with later expiration dates compared to those with earlier expiration dates. That means a collision with an identification code that will expire soon is preferred over a collision with an identification code that will expire later.

Pursuant to another embodiment, separate identification code spaces are used for relay nodes and base stations, in particular for relay nodes, mobile relay nodes and/or base stations.

It is noted that separate identification codes could be used for different kinds of relay nodes, e.g., stationary relay nodes and mobile relay nodes and/or for relay nodes with different movement characteristics.

Hence, a PCI ID space could be distributed among said entities. Advantageously, colliding nodes are of the same type, e.g., a collision between PCIs of mobile relay nodes will not affect mobile terminals that are connected to another type of node, e.g., a base station. Also, different sets of relay nodes can be assigned to different PCI ID spaces, avoiding collisions between relay nodes from different sets.

It is noted that the approach presented provides a solution for assigning identification codes for relay nodes in a way that avoids or reduces collisions with other relay nodes or base stations. If nevertheless the collision occurs, it can be solved as suggested herein.

According to an embodiment, a conflict of identification codes is determined by the relay node and said conflict is indicated to the base station or a conflict of identification codes is determined by the base station.

The conflict of identification codes could be that the relay node detects a node with the same identification code. The relay node informs its base station about the conflict. This can be achieved by sending a message from the relay node to the base station.

The base station can detect an approaching mobile relay node, e.g., based on measurement reports from its UEs: Many of the base station's UEs may simultaneously report an increasing signal level of the approaching mobile RN.

According to another embodiment, the base station determines by itself or by communicating with another node, in particular a base station that is a donor base station for a relay node that inflicts the conflict, at least one criterion, based on which a decision is made which relay node has to conduct a restart or which relay node has to reduce its transmission power.

In particular the two base stations may solve the conflict together, which relay node to restart or for which relay node to reduce the transmit power. It is noted that the transmit power could be reduced asymmetrically; for example, the relay node conveying a huge amount of valuable traffic can be instructed to reduce its transmit power slightly (or not at all) and the other relay node (e.g., a fast moving relay node attached to a train) may be instructed to (temporarily) reduce its transmit power significantly. This limits the interference for the time the moving relay node traverses the coverage area of the other relay node.

It is noted that the base station may solve the conflict by itself as it may be aware of sufficient criteria (conveyed, e.g., by measurement reports or messaging) to make the decision without having to confer with another base station.

In yet another embodiment, the base station determines at least one criterion, based on which a decision is made to pro-actively conduct a handover and in particular to restart the relay node with a different identification code. By performing a pro-active handover away from the cell that is going to be reconfigured, an impact of the reconfiguration on ongoing connections can be avoided. The handover can be conducted towards another cell in the vicinity, e.g., another cell of the same relay node in case it has multiple cells, or even to the new identification code to be configured after the restart (see also below).

The decision could be made to handover traffic from an approach relay node and to restart the approaching relay node or to handover traffic from the already present relay node and to restart this already present relay node.

According to a next embodiment, before the relay node is restarted with a new identification code, mobile terminals that are connected to this relay node are requested to perform a handover.

It is noted that the new identification code does (at least momentarily due to actual measurements, reports and/or historical information) not collide with existing (adjacent) identification codes.

It is an option that the mobile terminals (or a portion thereof) get connected to this relay node after it has been restarted with the new identification code. As an alternative, the mobile terminals (or a portion thereof) may get connected to another relay node or base station.

This allows changing the identification code of a relay node with a minimum impact on the mobile terminals connected to the relay node. Before the relay node reconfigures its identification code (which may include reconfiguring other parameters of the cell, e.g., applying different scrambling codes or different cyclic redundancy codes), the relay node may request the mobile terminals that are connected to it to perform a handover to the same relay node after reconfiguration with this new identification code. At the time of this handover command (request), the relay node may typically not yet transmit signals using the new identification code, because the reconfiguration is not finished. The mobile terminals can nonetheless start searching for this new identification code and if the relay node reconfigures quickly enough the new identification code can be found in time and the mobile terminals can perform a handover to that new cell (which is actually the reconfigured old relay node). Hence, reconfiguration of the identification code can be effectively hidden from the mobile terminals; in fact, from the mobile terminals' perspective the reconfigured relay node appears as a newly emerging relay node. In order to ease the reconfiguration, the mobile terminals may be instructed to search for the new relay node with the new identification code for a longer time period than during an ordinary handover. This can be achieved, e.g., by setting a timer limiting the search duration to a higher value compared to a time period used for the ordinary handover. In a further embodiment the relay node may have already sent (at least partial) signals using the new identification code before it is fully reconfigured in order to make its detection more reliable for the mobile terminals.

Pursuant to yet an embodiment, the at least one criterion comprises:
a time period since the relay node has conducted a restart;
a number of mobile terminals that are being served by the relay node;
a total load of the relay node;
a percentage and/or an amount of real-time, valuable or high-QoS traffic;
an indication whether there is a backup-capacity for the relay node available to take over its mobile terminals.

These criteria (or a portion thereof) can be used to decide how to solve the conflict of colliding identification codes, in particular which relay node may keep its identification code and which relay node has to conduct a restart. Once the decision is made, the donor base station of the relay node could instruct the relay node to handover all its mobile terminals and to conduct a restart with a different identification code.

According to a further embodiment, the at least one criterion is conveyed via a message, in particular comprising compressed data.

For example, the different criteria can be compressed into numeric values (for example, the total load of the relay node can attribute to a certain percentage of a value that indicates a measure for maintaining the connection and not conducting a restart). The base stations can compute this value for their relay nodes and exchange it with other base stations in order to resolve or avoid a collision. For example, the relay node with a value indicating the least disturbance of the network is restarted with a different identification code. In particular if many criteria are used to determine the degree of disturbance to restart a particular node, not all these criteria but only a single value can be communicated instead of giving the summary value of that evaluation. This may reduce the overhead accordingly.

Pursuant to an embodiment, the relay node is attached to a vehicle, in particular a train or a bus.

Preferably, the relay node is attached to a vehicle with a well-defined mobility pattern.

The problem stated above is also solved by a device for processing data in a wireless network comprising a processing unit that is arranged for assigning at least one identification code such that collisions with identification codes of neighboring relay nodes or neighboring base stations are reduced, avoided or solved.

It is noted that the steps of the method stated herein may be executable on this processing unit as well.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

According to an embodiment, the device is a relay node that is connectable or connected with a base station.

According to a further embodiment, the device is a base station that is connectable to at least one relay node.

According to yet another embodiment, the device has a base station functionality and a relay node functionality.

Hence, the device can be deployed as base station and/or as a (mobile) relay node.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a communication system comprising at least one device as described herein.

Embodiments of the invention are shown and illustrated in the following figures:

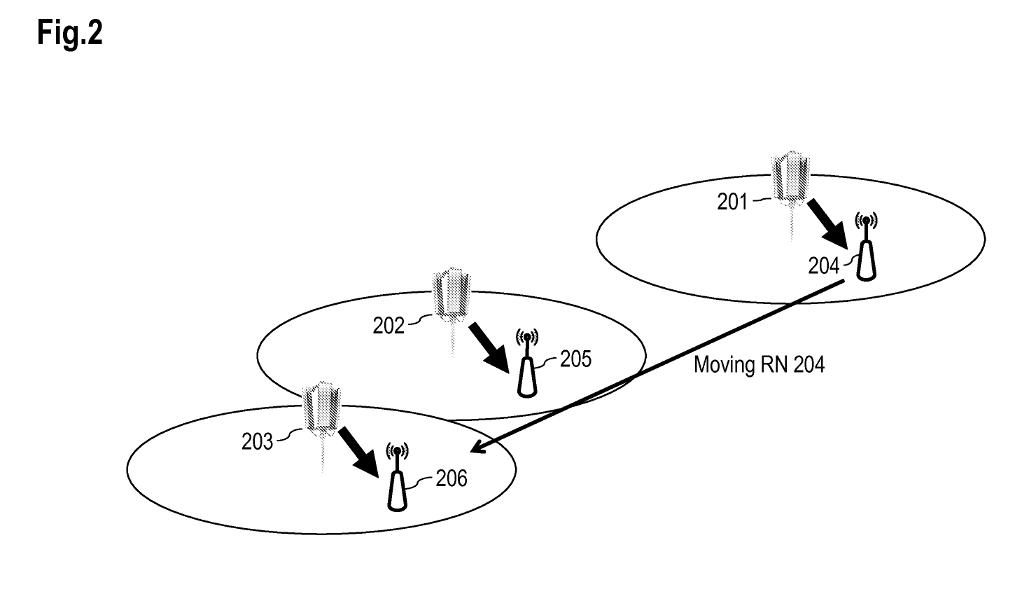

FIG. 2 shows a schematic diagram depicting three DeNBs, wherein a RN is attached to each DeNB;

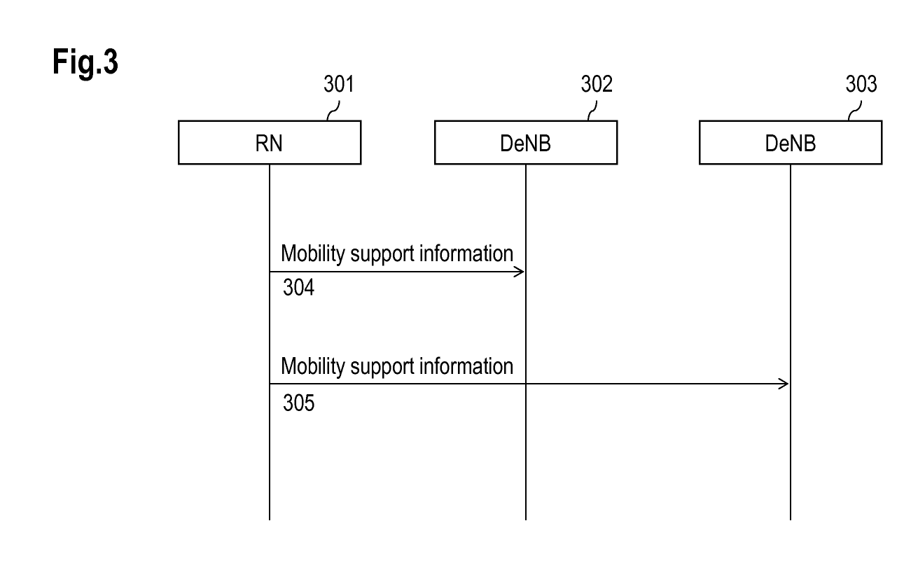

FIG. 3 shows a schematic message flow diagram comprising a mobile RN and two DeNBs;

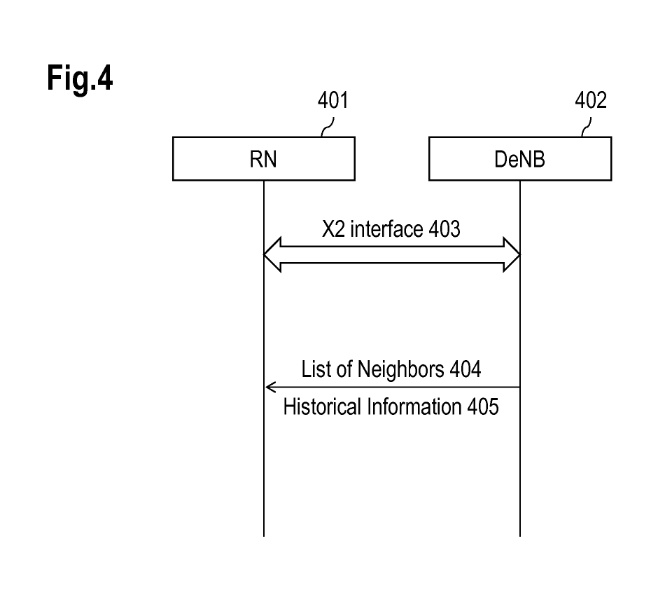

FIG. 4 shows a schematic message flow diagram comprising a RN and a DeNB, wherein an X2 interface has been established between the RN and the DeNB and information is conveyed via said X2 interface, said information could be utilized to determine an admissible PCI;

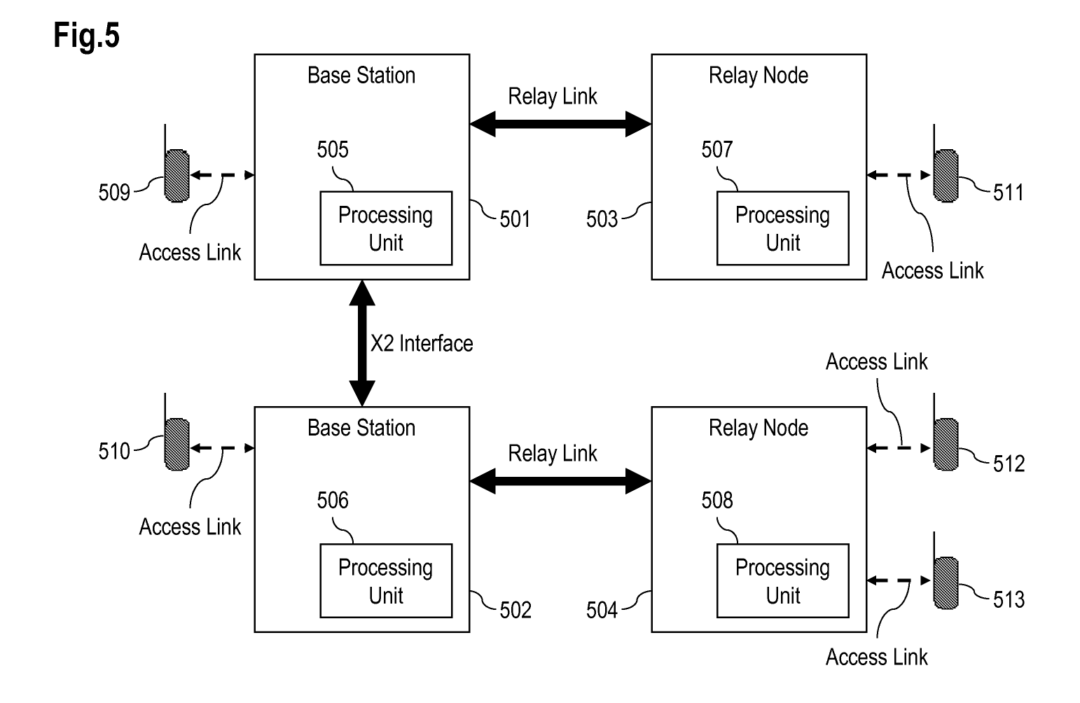

FIG. 5 shows a schematic block diagram comprising two base stations and two relay nodes that serve several mobile terminals.

The deployment of a relay node (RN) increases the probability of a PCI collision. This probability increases even further in case the relay node is mobile.

FIG. 2 shows a schematic diagram depicting three DeNBs, wherein a RN is attached to each DeNB. Hence, a RN 204 is attached to a DeNB 201, a RN 205 is attached to a DeNB 202 and a RN 206 is attached to a DeNB 203. Due to the distance between the DeNBs 203 and 201, the RN 206 cannot detect the DeNB 201 and vice versa. Hence, the RN 206 and the RN 204 may be assigned the same PCI. Due to its mobility, the RN 204 may change its location and enter the coverage area of the DeNB 203 and thus be in the vicinity of the RN 206. This results in a PCI confusion and/or collision that is resolved by reconfiguring and/or restarting either RN 204 or RN 206 with a different PCI.

The approach presented herewith reduces the probability that such a PCI collision occurs.

For example, during an initial setup, a mobility support information of the RNs is communicated to the DeNBs, e.g., via a dedicated message from the RN, a MME, a HSS, or another network node. FIG. 3 shows a schematic message flow diagram comprising a RN 301 and two DeNBs 302, 303. A mobility support information 304 is sent from the RN 301 to the DeNB 302 and a mobility support information 305 is sent from the RN 301 to the DeNB 303. This way, the DeNBs 302, 303 become aware of the fact that the RN 301 is mobile and may enter their coverage area; hence, they may avoid using the same PCI as does the RN 301 or they may inform the RN 301 of PCIs that should not be used in order to avoid a potential collision.

When an X2 interface is setup between the DeNB and the RN, the DeNB may include a list of neighbors and their PCIs. In addition (e.g., in case the RN is a mobile RN), the DeNB may include its immediate neighbors and the neighbors' neighbors in such list.

It is noted that instead of the X2 interface setup, a separate message could be used to communicate the neighbors of the neighbors to the RN (before the X2 interface is actually setup).

The list provides the RN with additional data (PCIs) to consider. The RN becomes aware of PCIs used in an extended neighborhood and a PCI collision could be prevented by choosing a PCI for the RN that is not already allocated by another node.

As an option, the DeNB may keep a historical information of the mobile RNs that it was serving, even if such RNs are no longer associated with this DeNB. The PCIs of such RNs could be attached to the aforementioned list and conveyed to the RN prior to its PCI allocation. This ensures that the RN will not be assigned a PCI that is being used by a mobile RN that could be expected to enter its coverage area in the near future. The historical information can be combined with an expiration date after which the history is no longer considered relevant and PCIs that are older than a predetermined date are deleted.

FIG. 4 shows a schematic message flow diagram comprising a RN 401 and a DeNB 402, wherein an X2 interface 403 has been established between the RN 401 and the DeNB 402. The DeNB 402 conveys a list of neighbors 404 (e.g., comprising the immediate neighbors and the neighbor's neighbors) optionally including a historical information 405 (of PCIs used in the past). This information can be used by the RN 401 to determine a PCI that may less likely lead to any collision with existing base stations or RNs.

FIG. 5 shows a schematic block diagram comprising a base station 501 (DeNB) with a processing unit 505 and a base station 502 (DeNB) with a processing unit 506. A relay node 503, comprising a processing unit 507, is attached via a relay link to the base station 501 and a relay node 504, comprising a processing unit 508, is attached via a relay link to the base station 502. The base station 501 and the base station 502 are connected via an X2 interface. The relay nodes 503, 504 may also comprise an X2 interface with the base stations 501, 502. Several mobile terminals 509 to 513 are connected to the base stations 501, 502 or to the relay nodes 503, 504 via access links.

It is noted that the functionality described herein can be implemented with the processing units of the base stations 501, 502 and/or the relay nodes 507, 508.

It is further noted that a device can provide a combined functionality operating either as a base station 501, 502 or as a relay node 503, 504.

It is noted that the block structure shown in any of the figures could be implemented by a person skilled in the art in various ways, e.g., by providing various physical units. The base station or the relay node, in particular the processing units, could be realized each as at least one logical entity that may be deployed as hardware, program code, e.g., software and/or firmware, running on a processor, e.g., a computer, microcontroller, ASIC, FPGA and/or any other logic device.

The functionality described herein may be based on an existing component of a (wireless) network, which is extended by means of software and/or hardware. The eNB mentioned herein could also be referred to as any base station pursuant to any communication standard.

The base station or the relay node may each comprise at least one physical or logical processing unit that is arranged for assigning at least one identification code such that collisions with identification codes of neighboring relay nodes or neighboring base stations are reduced, avoided or solved.

RN PCI Collision Resolution Optimization

The solution described above reduces the risk of a collision. However, in case a PCI collision occurs, this may lead to a radio link failure (RLF) with all of a node's active UEs, forcing them to drop their bearers and re-attach with a neighboring node.

Hereinafter a concept will be described that handles a PCI collision (which is far more unlikely to occur compared to the prior art, but not completely impossible) in an efficient manner.

A first approach would be to use separate PCI ID spaces, e.g., for RNs and (D)eNBs, which avoids collision between the PCIs of the RNs and the DeNBs. However, for some deployment scenarios, this may not suffice as for every DeNB there could be tens of RNs; hence, most of the nodes will be RNs and the PCI ID space will be too small. The advantage of separate PCI ID spaces, however, is that colliding nodes will be RNs and re-starting RNs may be better than to risk restarting a (D)eNB, which serves a larger coverage area compared to the RN. Also, the (D)eNB may serve several RNs that would lose their connection with the UEs in case the (D)eNB needs to be restarted.

When a RN that is already up and running finds out that another node is using the same PCI (this can be determined in case a mobile RN arrives in the neighborhood or in case an initial checking of PCIs was not accurate or something went wrong during the startup of the newly discovered node), the RN may not simply conduct a restart with another PCI. Instead, the RN may communicate the problem to its DeNB. The DeNB can communicate with the DeNB of the RN causing the conflict and the two DeNBs can resolve the issue together based on different criteria, comprising e.g.:
How long has it been since the RN started?
How many active UEs are being served by the RN?
What is the total load of each RN?
Which RN is serving a higher percentage of real time traffic?/How large is the percentage (for each RN) of real-time or (other) valuable traffic (e.g., traffic of high QoS)?
Does the DeNB, another RN within the DeNB or another neighboring node provide sufficient capacity to handover active UEs in case a restart of the RN is required?

These criteria (or a portion thereof) can be used to decide how to solve the conflict of colliding PCIs, in particular which RN keeps its PCI and which RN is restarted. Once the decision is made, the DeNB of the RN to be restarted can indicate to the RN to handover all its UEs (to the DeNB or some other node), and to restart with another PCI.

In case of two colliding RNs (using the same PCI) it could be an approach to determine which RN has to be prioritized (according to the criteria mentioned above). Instead of restarting the RN that is considered to cause fewer disturbances to the network, the transmission power of this RN could be reduced. It is also an option to reduce the transmission power of both RNs using the same PCI. The transmission power could be reduced symmetrically or asymmetrically, wherein the transmission power of the RN that would otherwise have to be restarted is reduced more than the transmission power of the other RN. This solution may be beneficial for fast moving RNs, wherein a time during which the collision occurs can be bypassed without having to conduct a restart. During that time there may still be PCI confusion and as a consequence a measurement of a UE triggering a handover to such an ambiguous PCI may lead to a wrong handover decision. This can be avoided by temporarily inhibiting handovers to such a temporarily ambiguous PCI.

Hence, according to the solutions presented herein, PCI collisions are largely avoided and for the rare situations that they cannot be avoided, a concept to efficiently resolve a collision with none or only minor disturbance of ongoing traffic is suggested.

The solution can be implemented in a way that it is completely transparent to the UEs; hence, no adjustment of the UEs is required. Minor updates can be conducted in the DeNBs and the RNs in particular to enable the identification of mobile RNs (in case mobile RNs are to be supported) and/or the negotiation of which RN to restart.

It is noted that additional messages between the eNB and RN can be defined to communicate the PCI list of neighbors and neighbors' neighbors from the DeNB to the RN. In addition, a message may indicate a RN to conduct a restart. Another (or this) message could be used to force the RN to be restarted to handover all its UEs to another cell (the destination cell could be part of such message).

Further advantages and embodiments:
(1) A depth of the list comprising the neighbors of the neighbors can be dynamically specified. For example, a depth value “0” indicates the parent node (only), a value “1” indicates immediate neighbors (only), a value “2” indicates immediate neighbors and neighbors of the immediate neighbors, etc.
(2) Reporting neighbors and neighbors of neighbors (depths value “1” and “2” as suggested under (1) above) can be implemented straightforward, as a node gets a list of the neighbors of its neighbor during an X2 setup or a reconfiguration update. The eNB may thus compile the lists from all of its neighbors (after removing some duplicates as different neighbors can be neighbors of the same node) to reach the list with the depth of up to 2.
(3) A mobile RN can be expected to be mounted on a vehicle (e.g., a bus, a train, any kind of public transportation, etc.) with a well-defined mobility pattern, which can be used to set the depth value of neighbor relations. For example, busses of a certain line may travel along the same route. Hence, it may be sufficient to assign two PCIs to all the busses of one specific line (one for each direction to avoid ambiguities when busses running in different directions cross their ways). It may also be necessary to ensure that the busses' PCIs are not used by RNs (or eNBs) along the route of the busses. At terminal end points, passengers will typically disembark and a restart could be admissible (rather than restarting an eNB in this area).
(4) The (mobile) RN's PCI can remain stored in the list of the DeNB's neighbors for a given period of time also after the RN has handed over its UEs to a target DeNB. When this period of time expires, the RN's PCI can be deleted from the list. Also, this period of time can be set (configured) dynamically.
(5) The DeNB can detect an approaching mobile RN (for example, based on a measurement report pattern of its UEs: many of the UEs may simultaneously report an increasing signal level of the approaching mobile RN). If the approaching RN uses the same PCI as one of the RNs served by the DeNB, the DeNB may pro-actively order the RN to handover its UEs and restart with another PCI before the mobile RN becomes close enough to cause a PCI collision. The decision to handover and restart may be based on at least one of the criteria indicated above; hence, as a result, the DeNB may instruct the approaching mobile RN or its RN using the same PCI as does the approaching RN to handover its UEs.
(6) If some of the information that could be used to resolve a PCI collision is already available from previous messages (e.g., previous load balancing messages), the decision to restart or not to restart a particular RN can be made in a distributed manner by a single DeNB, without the need for negotiation with other (affected) DeNBs.
(7) Communicating all information required to make the collision resolution decision may lead to a large amount of data (overhead data). Instead, the different criteria can be compressed into numeric values (for example, the total load of the RN can attribute to a certain percentage of this value). The DeNBs can compute this value for their RNs and exchange it in order to make the collision resolution.
(8) As an option, the UEs can be handed over to a RN that is to be established with a non-colliding PCI. This is feasible even if that PCI is not on air at the time the handover command is sent: In case the RN starts up quickly enough, it will be active once the UEs start searching for it. Therefore the reconfiguration of the PCI can also be done during such a RN handover.
(9) A more granular ID space separation between the RNs and the (D)eNBs can be an option. For example, three different ID spaces can be used: one for (D)eNBs, one for static RNs and one for mobile RNs. Hence, the collision will occur between mobile RNs only and not affect the other nodes. Similarly, different ID spaces can be reserved for RNs with different movement characteristics, e.g., travel patterns, direction and/or speed: For example, on a railway track RNs on northbound trains can use different PCIs as southbound trains. This typically eliminates collisions of RNs that are arranged onboard trains that meet along the tracks. If even eastbound and westbound traveling RNs (attached to, e.g., trains) get specific PCI spaces, also collisions on a junction (e.g., a station where passengers can change trains) can be avoided. Accordingly, high speed long distance trains can be assigned PCIs from a different range as low speed local trains, avoiding collisions during the time when a fast train is in the vicinity of a slow one (either en route or during a stop in a station).
(10) If a RN transmits on several cells or sectors, similar to typical base stations that have, e.g., 3 sectors in different directions, each sector may have to be configured with a unique PCI. The approach presented herein can be applied for each such sector accordingly. This may lead to a similar behavior as if there were collocated RNs each with one single sector. Further, when one sector is being reconfigured and/or restarted, UEs can be served temporarily by another sector. For that purpose, these UEs can be handed over to one of the remaining sectors and this sector can temporarily use the antennas of the sector under reconfiguration to better reach these UEs.

### LIST OF ABBREVIATIONS

3GPP 3rd Generation Partnership Project
DeNB Donor eNB
DHCP Dynamic Host Configuration Protocol
DVB Digital Video Broadcasting
DVB-H DVB—Handheld
eNB Evolved NodeB (base station)
HeNB Home eNB
HSS Home Subscriber Server
ID Identity
L1 Layer 1
L3 Layer 3
LTE 3GPP Long Term Evolution Radio Network
LTE-A LTE Advanced
MAC Media Access Control
MME Mobility Management Entity
NodeB, NB Base station
OAM Operation, Administration and Maintenance
PCI Physical Cell Identifier
QoS Quality of Service
RAN Radio Access Network
RLC Radio Link Control
RLF Radio Link Failure
RN Relay Node
RS Relay Station (also referred to as Relay Node)
SON Self Organizing Network
UE User Equipment

1. A method for processing data in a wireless network,
wherein a relay node is served by a base station,
wherein the relay node is assigned at least one identification code such that collisions with identification codes of neighboring relay nodes or neighboring base stations are reduced, avoided or solved.

2. The method according to claim 1, wherein the identification code is a physical cell identifier.

3. The method according to claim 1, wherein a mobility support information of the relay node is conveyed to base stations to which relay nodes can get connected.

4. The method according to claim 1, wherein a list of neighbors is conveyed to the relay node and the identification codes of this list are excluded from being assigned to the relay node.

5. The method according to claim 4, wherein a depth of the list of neighbors can be dynamically set.

6. The method according to claim 1, wherein historical information comprising recent identification codes is stored for a predefined period of time and the recent identification codes are not assigned to the relay node.

7. The method according to claim 1, wherein separate identification code spaces are used for relay nodes and base stations, in particular for relay nodes, mobile relay nodes and/or base stations.

8. The method according to claim 1, wherein a conflict of identification codes is determined by the relay node and said conflict is indicated to the base station or wherein a conflict of identification codes is determined by the base station.

9. The method according to claim 8, wherein the base station determines by itself or by communicating with another node, in particular a base station that is a donor base station for a relay node that inflicts the conflict, at least one criterion, based on which a decision is made which relay node has to conduct a restart or which relay node has to reduce its transmission power.

10. The method according to claim 8, wherein the base station determines at least one criterion, based on which a decision is made to pro-actively conduct a handover and in particular to restart the relay node with a different identification code.

11. The method according to claim 10, wherein, before the relay node is restarted with a new identification code, mobile terminals that are connected to this relay node are requested to perform a handover.

12. The method according to claim 9, wherein the at least one criterion comprises:
a time period since the relay node has conducted a restart;
a number of mobile terminals that are being served by the relay node;
a total load of the relay node;
a percentage and/or an amount of real-time, valuable or high-QoS traffic;
an indication whether there is a backup-capacity for the relay node available to take over its mobile terminals.

13. The method according to claim 12, wherein the at least one criterion is conveyed via a message, in particular comprising compressed data.

14. A device for processing data in a wireless network comprising a processing unit that is arranged
for assigning at least one identification code such that collisions with identification codes of neighboring relay nodes or neighboring base stations are reduced, avoided or solved.

15. The device according to claim 14, wherein the device is a base station that is connectable to at least one relay node.

16. The device according to claim 14, wherein the device has a base station functionality and a relay node functionality
